(19) United States
(12) Patent Application Publication
(10) Pub. No.: US 2014/0063813 A1
(43) Pub. Date: Mar. 6, 2014

(54) Projection Lamp

(71) Applicant: ARCLITE OPTRONICS CORP., Hu-Kou Township (TW)

(72) Inventors: Lung Chen, Hu-Kou Township (TW); Hui-Hsiang Feng, Hu-Kou Township (TW); Ya-Chuan Yeh, Hu-Kou Township (TW)

(73) Assignee: Arclite Optronics Corp., Hu-Kou Township (TW)

(21) Appl. No.: 13/679,990

(22) Filed: Nov. 16, 2012

(30) Foreign Application Priority Data
Sep. 3, 2012 (TW) 101216958

(51) Int. Cl. F21V 7/00

(52) U.S. Cl. CPC F21V 7/0033
USPC 362/298

(57) ABSTRACT

A projection lamp includes a bulb, a main reflective cover and a secondary reflective cover. The bulb includes a wick and a lamp tube which wraps the wick. The wick is configured to emit divergent light beams while the bulb is lit up. The main reflective cover is connected to the lamp tube and includes a main reflective surface facing the wick. The main reflective surface is configured to convert the divergent light beams into projection beams. The secondary reflective cover is melt bonded to the lamp tube and includes a secondary reflective surface facing both of the wick and the main reflective surface. The secondary reflective surface is configured to reflect a portion of the divergent light beams, cannot be directly emitted onto the main reflective surface, onto the main reflective surface while the bulb is lit up.

### TECHNICAL FIELD

The present invention relates to a projection lamp, and more particularly to a projection lamp used as a light source (so-called projector light) for a projector and suitable for various occasions of the projected light applications such as stage projection lighting.

### BACKGROUND

Because with functions of enlarging images and projecting the enlarged images onto a screen, projector is an imaging equipment commonly used on some specific events and occasions, such as business meetings, banquets and home theaters. In a projector, a display device first processes the light beams emitted from a projection lamp to the image beams, and a projective lens then projects the image beams onto a screen so as to form images on the screen. Thus, it is understood that the projection lamp is an essential component in a projector.

FIG. 1 is a schematic view of a conventional projection lamp. As shown, the divergent light beams, emitted through between the optical paths A and B of the wick W, are referred to as valid light beams due capable of being emitted onto the main reflective surface M1 of the main reflective cover M. Then, the valid light beams are reflected by the main reflective surface M1 and thereby being converted into the projection beam. In another case, the divergent light beams, emitted through between the optical paths B and C of the wick W, are referred to as invalid light beams due to unable to be emitted onto the main reflective surface M1 and consequently cannot be reflected by the main reflective surface M1. Thus, the means to convert the invalid light beams into the valid light beams and thereby enhancing the light projection efficiency of the projection lamp is a very important topic.

FIG. 2 is a schematic view illustrating a conventional mean to enhance the light projection efficiency of a projection lamp, which is introduced in the textbook “Projection Lamp Design” published by teacher Huangfu Bingyan of Fudan University in mainland China in March 1998. As shown in FIG. 2, the conventional projection lamp 100 includes a main reflective cover 120, which is disposed on a side of a wick 110 and configured to converge the divergent light beams 112 emitted from the wick 110 into the light beams 113. In addition, to enhance the light utilization efficiency, the conventional projection lamp 100 further includes a secondary reflective cover 130, which is disposed on another side of the wick 110 and configured to reflect the light beams emitted thereon onto the main reflective cover 120. Thus, the conventional projection lamp 100 can have higher light projection efficiency and the projection beams can have higher brightness; accordingly, the projection lamp 100 is suitable to use in some specific equipments and occasions, such as projectors and stage projection lighting requiring higher projection brightness.

Generally, the wick 110 is wrapped by a lamp tube. Although in the book “Projection Lamp Design” does not describe the fixing means of the main reflective cover 120 and the secondary reflective cover 130, it is understood that the lamp tube and the reflective cover are fixed to each other by using binder or adhesive. For example, Taiwan Patent (patent No. 90111710) discloses means of fixing a lamp tube and a reflective cover by using blinder and another Taiwan Patent (publish No. I235303) discloses means of bonding a main reflective cover to a lamp tube, which wraps a wick, by using adhesive. Thus, it is apparent to those ordinarily skilled in the art to understand that the lamp tube and the main reflective cover as well as the secondary reflective cover are commonly fixed to each other by adhesive.

However, the wick may result in heat when the lamp is lit up; and the heat will be transmitted to the secondary reflective cover through the adhesive due to the secondary reflective cover is disposed close to the high temperature zone of the wick. Due to the relatively large thermal expansion coefficient difference between the adhesive and the lamp tube as well as the secondary reflective cover both, the secondary reflective cover may crack or the lamp tube may burst by the corresponding thermal stress generated by the high temperature.

### SUMMARY OF EMBODIMENTS

Therefore, an object of the present invention is to provide a projection lamp with higher reliability.

The present invention provides a projection lamp, which includes a bulb, a main reflective cover and a secondary reflective cover. The bulb includes a wick and a lamp tube which wraps the wick. The wick is configured to emit divergent light beams while the bulb is lit up. The main reflective cover is connected to the lamp tube and includes a main reflective surface facing the wick. The main reflective surface is configured to convert the divergent light beams into projection beams. The secondary reflective cover is melt bonded to the lamp tube and includes a secondary reflective surface facing both of the wick and the main reflective surface. The secondary reflective surface is configured to reflect a portion of the divergent light beams, cannot be directly emitted onto the main reflective surface, onto the main reflective surface while the bulb is lit up. Thus, the projection lamp has enhanced light projection efficiency through employing the secondary reflective cover to reflect the divergent light beams, cannot be directly emitted onto the main reflective surface, onto the main reflective surface.

In one embodiment, the secondary reflective cover includes a substrate and a reflective layer. The substrate is melt bonded to the lamp tube and includes material of either glass or ceramic. The reflective layer is coated on a surface of the substrate facing the main reflective surface and thereby forming the secondary reflective surface.

In one embodiment, the lamp tube includes a spherical part, a first sealing part and a second sealing part. The first and second sealing parts are connected to two ends of the spherical part, respectively. The wick is located in a space surrounded by the spherical part. The main reflective cover includes a main reflection part and a first cylindrical part connected to the main reflection part. The main reflection part includes the main reflective surface. The first cylindrical part is disposed at the backside of the main reflective surface. The main reflection part includes a first penetrating hole. The first penetrating hole is communicatable with a first internal space of the first cylindrical part. The first sealing part extends into the first internal space via the first penetrating hole and protrudes from the first cylindrical part. The secondary reflective cover includes a secondary reflection part and a second cylindrical part connected to the secondary reflection part. The secondary reflection part includes the secondary reflective surface. The second cylindrical part is disposed at the backside of the secondary reflective surface. The secondary reflection part includes a second penetrating hole. The second penetrating hole is communicatable with a second internal space of the second cylindrical part. The second sealing part extends into the second internal space via the second penetrating hole and protrudes from the second cylindrical part. The second cylindrical part is melt bonded to the second sealing part.

The present invention further provides a projection lamp, which includes a bulb, a main reflective cover, a secondary reflective cover and a fixing member. The bulb includes a wick and a lamp tube which wraps the wick. The wick is configured to emit divergent light beams while the bulb is lit up. The main reflective cover is connected to the lamp tube and includes a main reflective surface facing the wick. The main reflective surface is configured to convert the divergent light beams into projection beams. The secondary reflective cover is connected to the lamp tube and includes a secondary reflective surface facing both of the wick and the main reflective surface. The secondary reflective surface is configured to reflect the divergent light beams onto the main reflective surface. The fixing member is configured to attach the secondary reflective cover and the lamp tube to each other; wherein the fixing member has no adhesiveness. Thus, the projection lamp has enhanced light projection efficiency through employing the secondary reflective cover to reflect the divergent light beams, cannot be directly emitted onto the main reflective surface, onto the main reflective surface.

In one embodiment, the secondary reflective cover includes a second cylindrical part. The fixing member is an annular member fixed to the second sealing part. The second cylindrical part of the secondary reflective cover is fixed to the fixing member.

In one embodiment, the fixing member is telescoped to the second sealing part and includes a first portion and a second portion connected to each other. The first portion is located between the wick and the second portion. The second cylindrical part is telescoped on an outer surface of the first portion.

In one embodiment, the fixing member surrounds a portion of the second sealing part and includes a first portion and a second portion connected to each other. The first portion is disposed between the wick and the second portion. The second cylindrical part is telescoped on an inner surface of the first portion.

In one embodiment, the aforementioned projection lamp further includes a first adhesive and a second adhesive. The first adhesive is for bonding the fixing member and the second cylindrical part to each other. The second adhesive is bonding the fixing member and the second sealing part.

In one embodiment, the fixing member is an elastic member engaged between the second cylindrical part and the second sealing part.

In one embodiment, the elastic member includes a plurality of metal domes.

In summary, through melt bonding the secondary reflective cover to the lamp tube of the bulb and thereby without the need of adhesive, the projection lamp of one embodiment can avoid the secondary reflective cover and lamp tube dehiscence issue, resulted by the stress caused by a relatively large expansion coefficient difference between the adhesive and the secondary reflective cover and the lamp tube under a relatively high temperature. In addition, through employing the fixing member to fix the secondary reflective cover to the lamp tube of the bulb so that the secondary reflective cover, the fixing member and the adhesive can have a relatively large distance to the high-temperature zone of the wick, the projection lamp of another embodiment can avoid secondary reflective cover and lamp tube dehiscence issue. Thus, the projection lamp of the present invention can have better reliability.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic view of a conventional projection lamp;

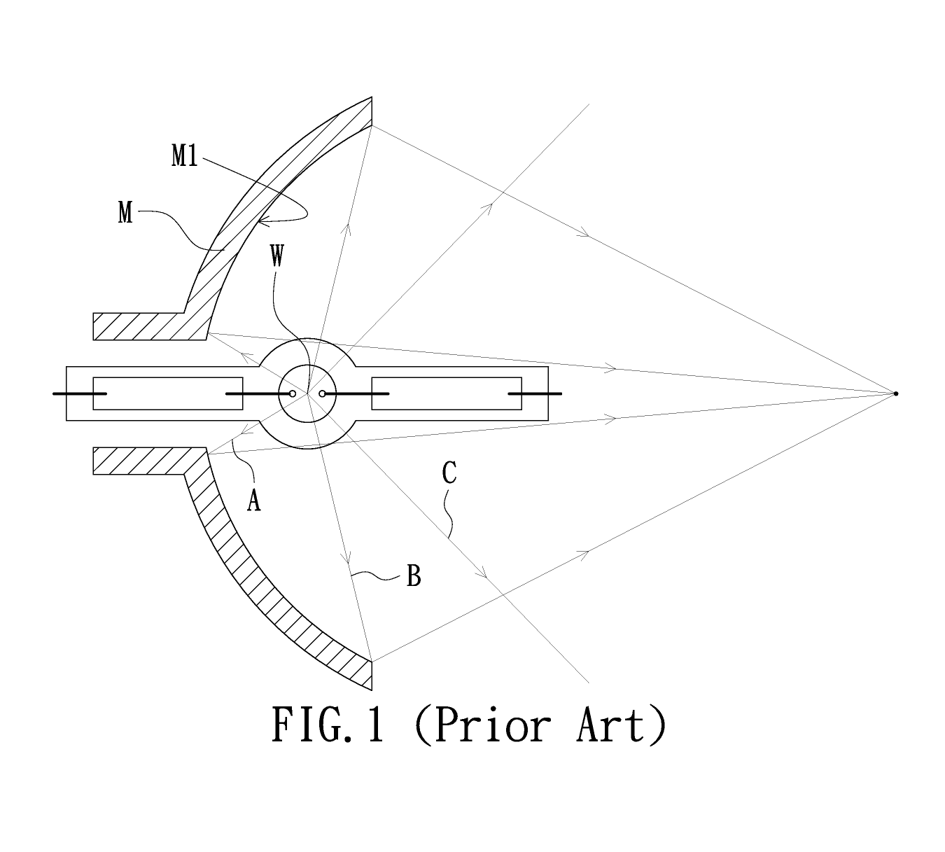

FIG. 2 is a schematic view illustrating a conventional mean to enhance the light projection efficiency of a projection lamp;

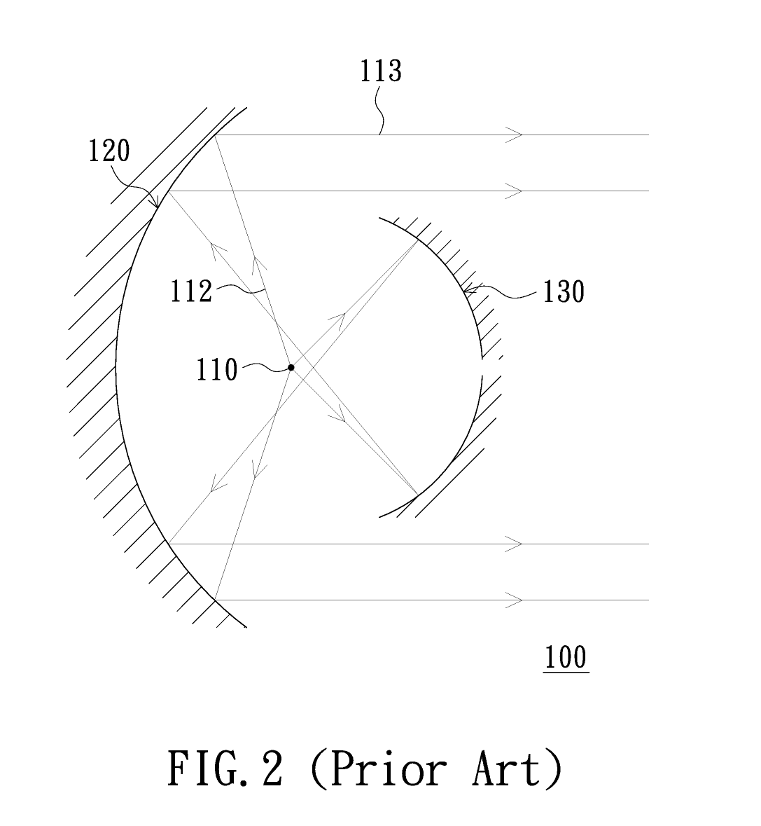

FIG. 3A is a schematic cross-sectional view of a projection lamp in accordance with an embodiment of the present invention;

FIG. 3B is a schematic view illustrating optical paths of the projection lamp shown in FIG. 3A;

FIG. 4A is a schematic cross-sectional view of a projection lamp in accordance with another embodiment of the present invention;

FIG. 4B is a schematic cross-sectional view of a projection lamp in accordance with still another embodiment of the present invention; and

FIG. 4C is a schematic cross-sectional view of a projection lamp in accordance with yet another embodiment of the present invention.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

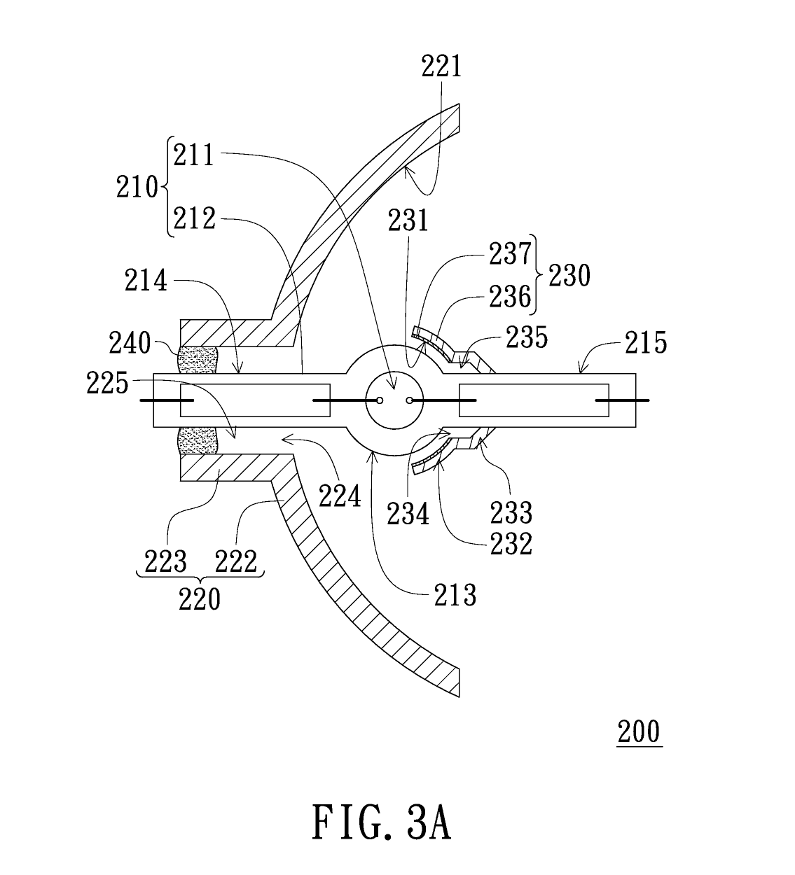

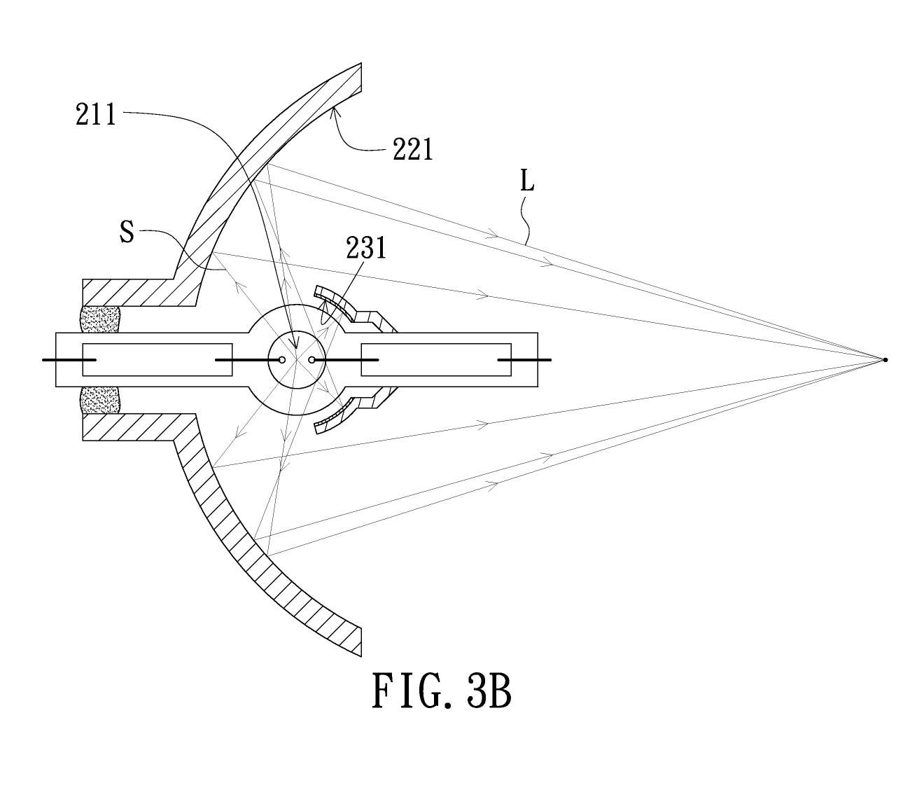

FIG. 3A is a schematic cross-sectional view of a projection lamp in accordance with an embodiment of the present invention; and FIG. 3B is a schematic view illustrating optical paths of the projection lamp shown in FIG. 3A. As shown in FIGS. 3A and 3B, the projection lamp 200 in this embodiment includes a bulb 210, a main reflective cover 220 and a secondary reflective cover 230. The bulb 210 includes a wick 211 and a lamp tube 212; wherein the wick 211 is wrapped by the lamp tube 212. The bulb 210 is configured to emit divergent light beams S while being supplied with electrical power and lit up. The main reflective cover 220 is connected to the lamp tube 212 and has a main reflective surface 221 facing the wick 211. The main reflective surface 221 is configured to convert the divergent light beams S emitted from the wick 211 into projection beams L. Specifically, the main reflective surface 221 is an elliptical spherical surface, and accordingly the wick 211 is located at the first focal point (i.e., the one nearer to the main reflective surface 221) of the elliptical spherical surface. Thus, after being projected onto the main reflective surface 221, the divergent light beams S emitted from various directions can be reflected to and concentrated at the second focal point of the elliptical spherical surface and thereby forming the projection beams L. In another embodiment, the main reflective surface 221 is a parabolic surface, and accordingly the wick 211 is located at the focal point of the parabolic surface. Thus, after being projected onto the main reflective surface 221, the divergent light beams S emitted from various directions can be reflected back via the same optical paths and thereby forming parallel projection beams L. It is to be noted that the geometric structure of the main reflective surface 221 and the corresponding arrangement position of the wick 211 can be modulated based on actual design requirements; and the present invention is not limited thereto.

The secondary reflective cover 230 is melt bonded to the lamp tube 212 and has a secondary reflective surface 231 facing both of the wick 211 and the main reflective surface 221. The secondary reflective surface 231 is configured to, while the bulb 210 is being supplied with electrical power and lit up, reflect the invalid divergent light beams S onto the main reflective surface 221 and thereby converting the invalid divergent light beams S into the projection beams L; wherein the invalid divergent light beams S herein are referred to the divergent light beams S cannot be directly projected onto the main reflective surface 221 from the wick 211. In this embodiment, the secondary reflective surface 231 is a spherical surface, and accordingly the wick 211 is located at the center of the spherical surface. Thus, after being projected onto the secondary reflective surface 231, the invalid divergent light beams S can be reflected onto the main reflective surface 221 via the same optical paths and thereby being converted into the projection beams L. Specifically, the projection beams L are functioned as illumination beams of a projector when the projection lamp 200 is equipped in the projector. Afterwards, the projection beams L are converted into image beams by a display element of the projector and then the image beams are projected onto a screen by a projection lens of the projector so as to form images on the screen.

In this embodiment, the secondary reflective cover 230 includes a substrate 236 and a reflective layer 237. The substrate 236 includes material of silicon dioxide; and the present invention is not limited thereto. Specifically, the material of the substrate 236 can be either glass or ceramic. The reflective layer 237 is a multilayer media interference reflective film, a polished surface of a substrate body, or other material having a high reflectance with luminescent effect. The substrate 236 is melt bonded to the lamp tube 212. The reflective layer 237 is coated on a surface of the substrate 236 facing the main reflective surface 221, and thereby forming the secondary reflective surface 231. In other embodiments, the secondary reflective cover 230 may have a monolayer structure made of one single material, or a multilayer structure made of multilayer material.

In addition, the lamp tube 212 includes a spherical part 213, a first sealing part 214 and a second sealing part 215. The first sealing part 214 and the second sealing part 215 are connected to two ends of the spherical part 213, respectively; and the wick 211 is located in a space surrounded by the spherical part 213. The main reflective cover 220 includes a main reflection part 222 and a first cylindrical part 223; wherein the first cylindrical part 223 is connected to the main reflection part 222. The main reflection part 222 has the main reflective surface 221; the first cylindrical part 223 is disposed at the backside of the main reflective surface 221; and the main reflection part 222 has a first penetrating hole 224. The first penetrating hole 224 is communicatable with a first internal space 225 of the first cylindrical part 223; and the first sealing part 214 extends into the first internal space 225 via the first penetrating hole 224 and protrudes from the first cylindrical part 223. The first sealing part 214 of the lamp tube 212 is boned to the inner surface of the first cylindrical part 223 of the main reflective cover 220 by an adhesive 240.

The secondary reflective cover 230 includes a secondary reflection part 232 and a second cylindrical part 233; wherein the second cylindrical part 233 is connected to the secondary reflection part 232. The secondary reflection part 232 has the secondary reflective surface 231; the second cylindrical part 233 is disposed at the backside of the secondary reflective surface 231; and the secondary reflection part 232 has a second penetrating hole 234. The second penetrating hole 234 is communicatable with a second internal space 235 of the second cylindrical part 233; the second sealing part 215 extends into the second internal space 235 via the second penetrating hole 234 and protrudes from the second cylindrical part 233; and the second cylindrical part 233 is melt bonded to the second sealing part 215.

Because being melt bonded to the second sealing part 215, the secondary reflective cover 230 can be stably fixed to the projection lamp 200 in this embodiment. Thus, the secondary reflective cover or lamp tube dehiscence issue, resulted from an over large thermal stress of the adhesive boned between the secondary reflective cover and the lamp tube in a conventional projection lamp under a relatively high temperature, can be avoided; and consequently the projection lamp 200 of the present invention has better reliability.

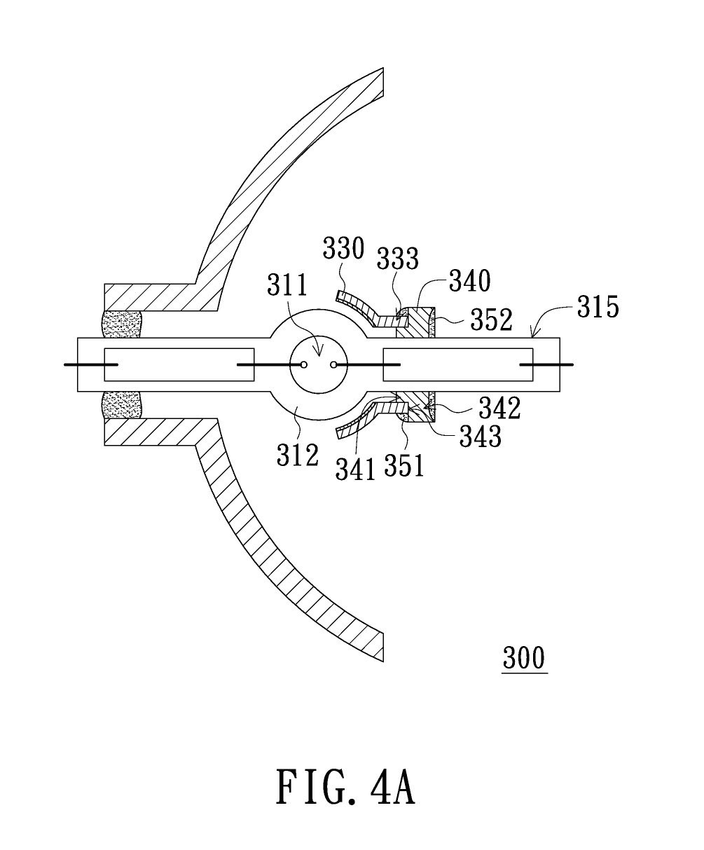

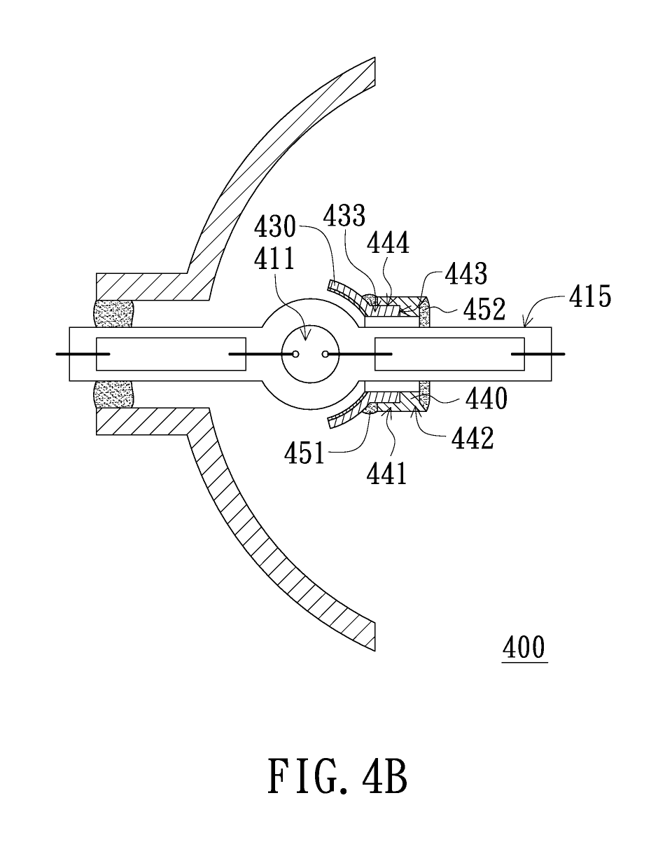

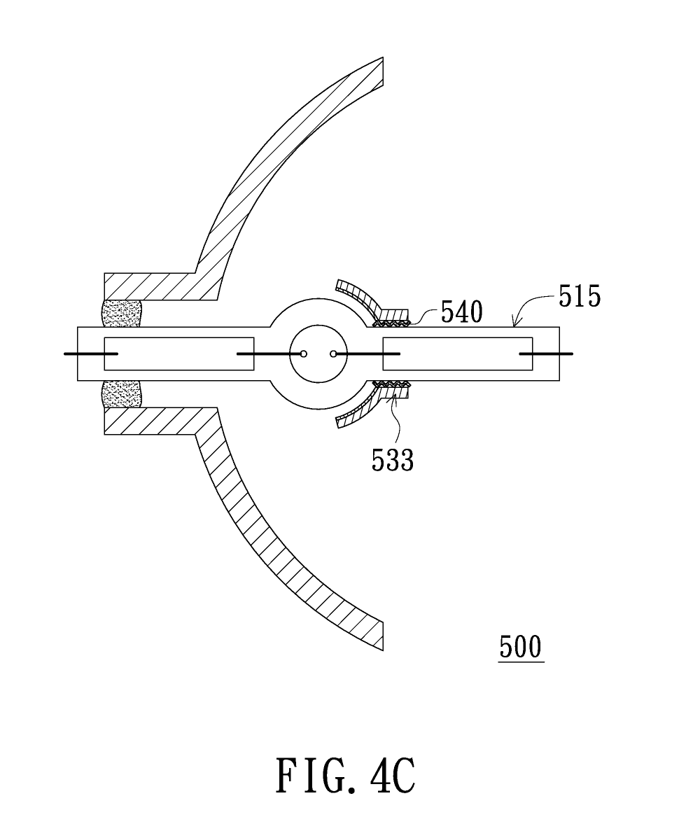

FIG. 4A is a schematic cross-sectional view of a projection lamp in accordance with another embodiment of the present invention. As shown, the projection lamp 300 in this embodiment has a structure similar to that of the aforementioned projection lamp 200; and the main difference between the two is the mean of fixing the secondary reflective cover to the lamp tube. In other words, the fixing between of the secondary reflective cover 330 and the lamp tube 312 in the projection lamp 300 is not realized by the melt bonding manner. Compared with the projection lamp 200, the projection lamp 300 in this embodiment further includes a fixing member 340 configured to fix the secondary reflective cover 330 and the lamp tube 312 to each other; wherein the fixing member 340 has no adhesiveness. Specifically, the fixing member 340 is an annular member fixed to the second sealing part 315 of the lamp tube 312; and the second cylindrical part 333 of the secondary reflective cover 330 is fixed to the fixing member 340. In this embodiment, the fixing member 340 is an annular member made of ceramic or other material without elasticity. In other embodiments, the fixing member 340 is an annular member is made of metal material with elasticity. In addition, the fixing member 340 is telescoped to the second sealing part 315 and includes a first portion 341 and a second portion 342 connected to each other. The first portion 341 is located between the wick 311 and the second portion 342. The second cylindrical part 333 of the secondary reflective cover 330 is telescoped on the outer surface of the first portion 341. The projection lamp 300 further includes a first adhesive 351 and a second adhesive 352. The first adhesive 351 is configured to bond the fixing member 340 and the secondary reflective cover 330 to each other; and the second adhesive 352 is configured to bond the fixing member 340 and the second sealing part 315 to each other. In this embodiment, the secondary reflective cover 330 and the second sealing part 315 are configured to engage to each other via the fixing member 340. Thus, while the bulb of the projection lamp 300 is lit up and produces heat, the fixing member 340 and the lamp adhesives 351, 352 each can have a lower temperature change due to the fixing point of the fixing member 340 and the lamp tube 312 is relatively far away the wick 311, and accordingly the fixing member 340, the adhesives 351, 352, the secondary reflective cover 330 and the lamp tube 312 can have similar thermal deformation degrees. Consequently, the secondary reflective cover 330 and the lamp tube 312 can be prevented from having dehiscence, which is resulted from the thermal stress generated by the relatively large deformation degree between the fixing member 340 and the lamp tube 312 while the projection lamp 300 is in operation.

It is to be noted that the aforementioned structure of the fixing member 340 is used for purposes of exemplification only; and the structure of the fixing member 340 can be modulated based on actual design requirements. For example, FIG. 4B is a schematic cross-sectional view of a projection lamp in accordance with still another embodiment of the present invention. As shown, the fixing member 440 in the projection lamp 400 of the embodiment surrounds a portion of the second sealing part 415 of the lamp tube and includes a first portion 441 and a second portion 442 connected to each other. The first portion 441 and the second portion 442 are configured to have the same outer diameter, the first portion 441 is configured to have an inner diameter greater than that of the second portion 442; and the present invention is not limited thereto. The first portion 441 is disposed between the wick 411 and the second portion 442. The second portion 442 has, for example, a stopper surface 443 connected to the first portion 441; the second cylindrical part 433 is telescoped on the inner surface 444 of the first portion 441 and is, for example, against on the stopper surface 443; and the present invention is not limited thereto. Likewise, the projection lamp 400 further includes a first adhesive 451 and a second adhesive 452. The first adhesive 451 is configured to bond the fixing member 440 and the secondary reflective cover 430 to each other; and the second adhesive 452 is configured to bond the fixing member 440 and the second sealing part 415 to each other.

FIG. 4C is a schematic cross-sectional view of a projection lamp in accordance with yet another embodiment of the present invention; specifically, the fixing member in this embodiment is an annular member with elasticity. As shown, the fixing member in the projection lamp 500 of this embodiment is realized by an elastic member 540, which includes a plurality of metal domes made of stainless steel or other metal material; wherein it is to be noted that the elastic member 540 is not limited to be made of metal material. The elastic member 540 is engaged between the second cylindrical part 533 and the second sealing part 515. Thus, by using the engaging manner of the elastic member 540, the projection lamp 500 can have shorter assembly time and lower manufacturing cost due to no need of additional adhesives or melt processing. Furthermore, the stress, resulted from the thermal expansion of the secondary reflective cover and the lamp tube, can be eliminated by the elastic deformation of the elastic member 540 while the projection lamp 500 is being supplied with electrical power and lit on, so that the secondary reflective cover and lamp tube dehiscence is avoided. In addition, it is understood that the projection lamp 500 in this embodiment has advantages same as that in the aforementioned embodiments; and no unnecessary detail is given here.

In summary, through melt bonding the secondary reflective cover to the lamp tube of the bulb and thereby without the need of adhesive, the projection lamp of one embodiment can avoid the secondary reflective cover and lamp tube dehiscence issue, resulted by the stress caused by a relatively large expansion coefficient difference between the adhesive and the secondary reflective cover and the lamp tube under a relatively high temperature. In addition, through employing the fixing member to fix the secondary reflective cover to the lamp tube of the bulb so that the secondary reflective cover, the fixing member and the adhesive can have a relatively large distance to the high-temperature zone of the wick, the projection lamp of another embodiment can avoid secondary reflective cover and lamp tube dehiscence issue. Thus, the projection lamp of the present invention can have better reliability.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection lamp, comprising:
a bulb comprising a wick and a lamp tube wrapping the wick, the wick being configured to emit divergent light beams while the bulb is lit up;
a main reflective cover connected to the lamp tube and comprising a main reflective surface facing the wick, the main reflective surface being configured to convert the divergent light beams into projection beams; and
a secondary reflective cover melt bonded to the lamp tube and comprising a secondary reflective surface facing both of the wick and the main reflective surface, the secondary reflective surface being configured to reflect a portion of the divergent light beams onto the main reflective surface while the bulb is lit up.

2. The projection lamp according to claim 1, wherein the secondary reflective cover comprises:
a substrate melt bonded to the lamp tube and comprising material of either glass or ceramic; and
a reflective layer coated on a surface of the substrate facing the main reflective surface and thereby forming the secondary reflective surface.

3. The projection lamp according to claim 1, wherein the lamp tube comprises a spherical part, a first sealing part and a second sealing part, the first and second sealing parts are connected to two ends of the spherical part, respectively, the wick is located in a space surrounded by the spherical part, the main reflective cover comprises a main reflection part and a first cylindrical part connected to the main reflection part, the main reflection part comprises the main reflective surface, the first cylindrical part is disposed at the backside of the main reflective surface, the main reflection part comprises a first penetrating hole, the first penetrating hole is communicatable with a first internal space of the first cylindrical part, the first sealing part extends into the first internal space via the first penetrating hole and protrudes from the first cylindrical part, the secondary reflective cover comprises a secondary reflection part and a second cylindrical part connected to the secondary reflection part, the secondary reflection part comprises the secondary reflective surface, the second cylindrical part is disposed at the backside of the secondary reflective surface, the secondary reflection part comprises a second penetrating hole, the second penetrating hole is communicatable with a second internal space of the second cylindrical part, the second sealing part extends into the second internal space via the second penetrating hole and protrudes from the second cylindrical part, and the second cylindrical part is melt bonded to the second sealing part.

4. A projection lamp, comprising:
a bulb comprising a wick and a lamp tube wrapping the wick, the wick being configured to emit divergent light beams while the bulb is lit up;
a main reflective cover connected to the lamp tube and comprising a main reflective surface facing the wick, the main reflective surface being configured to convert the divergent light beams into projection beams;
a secondary reflective cover connected to the lamp tube and comprising a secondary reflective surface facing both of the wick and the main reflective surface, the secondary reflective surface being configured to reflect the divergent light beams onto the main reflective surface; and
a fixing member configured to attach the secondary reflective cover and the lamp tube to each other, wherein the fixing member has no adhesiveness.

5. The projection lamp according to claim 4, wherein the lamp tube comprises a spherical part, a first sealing part and a second sealing part, the first and second sealing parts are connected to two ends of the spherical part, respectively, the wick is located in a space surrounded by the spherical part, the main reflective cover comprises a main reflection part and a first cylindrical part connected to the main reflection part, the main reflection part comprises the main reflective surface, the first cylindrical part is disposed at the backside of the main reflective surface, the main reflection part comprises a first penetrating hole communicatable with a first internal space of the first cylindrical part, the first sealing part extends into the first internal space via the first penetrating hole and protrudes from the first cylindrical part, the secondary reflective cover comprises a secondary reflection part and a second cylindrical part connected to the secondary reflection part, the secondary reflection part comprises the secondary reflective surface, the second cylindrical part is disposed at the backside of the secondary reflective surface, the secondary reflection part comprises a second penetrating hole communicatable with a second internal space of the second cylindrical part, the second sealing part extends into the second internal space via the second penetrating hole and protrudes from the second cylindrical part.

6. The projection lamp according to claim 5, wherein the fixing member is an annular member fixed to the second sealing part, and the second cylindrical part of the secondary reflective cover is fixed to the fixing member.

7. The projection lamp according to claim 6, wherein the fixing member is telescoped to the second sealing part and comprises a first portion and a second portion connected to each other, the first portion is located between the wick and the second portion, the second cylindrical part is telescoped on an outer surface of the first portion.

8. The projection lamp according to claim 6, wherein the fixing member surrounds a portion of the second sealing part and comprises a first portion and a second portion connected to each other, the first portion is disposed between the wick and the second portion, the second cylindrical part is telescoped on an inner surface of the first portion.

9. The projection lamp according to claim 6, further comprising:
a first adhesive for bonding the fixing member and the second cylindrical part to each other; and
a second adhesive for bonding the fixing member and the second sealing part.

10. The projection lamp according to claim 6, wherein the fixing member is an elastic member engaged between the second cylindrical part and the second sealing part.

11. The projection lamp according to claim 10, wherein the elastic member comprises a plurality of metal domes.
